(19) United States
(12) Patent Application Publication
(10) Pub. No.: US 2016/0048777 A1
(43) Pub. Date: Feb. 18, 2016

(54) RESERVATION MANAGEMENT METHOD AND RESERVATION MANAGEMENT APPARATUS

(71) Applicant: FUJITSU LIMITED, Kawasaki-shi (JP)

(72) Inventors: Eiji KITAGAWA, Akashi (JP); Takushi FUJITA, Chigasaki (JP); Takuro IKEDA, Yohohama (JP)

(73) Assignee: FUJITSU LIMITED, Kawasaki-shi (JP)

(21) Appl. No.: 14/513,339

(22) Filed: Oct. 14, 2014

(30) Foreign Application Priority Data
Aug. 15, 2014 (JP) 2014-165460

(51) Int. Cl. G06Q 10/02

(52) U.S. Cl. CPC G06Q 10/025

(57) ABSTRACT

A reservation management apparatus obtains reservation information including reserved trip information indicating a vehicle trip that has not departed and is reserved by one of a plurality of users and reserving user information indicating the user. The reservation management apparatus determines one or more other users who are associated with the same trip information as the user, with reference to history information associating information about users who took vehicle trips that were operated with different departure dates and times in the past with trip information indicating the vehicle trips. The reservation management apparatus outputs other user information indicating at least some of the determined other users in association with the reservation information.

### CROSS-REFERENCE TO RELATED APPLICATION

This application is based upon and claims the benefit of priority of the prior Japanese Patent Application No. 2014-165460, filed on Aug. 15, 2014, the entire contents of which are incorporated herein by reference.

### FIELD

The embodiments discussed herein relate to a reservation management method and a reservation management apparatus.

### BACKGROUND

At present, demand responsive transport systems are emerging, in which buses or other vehicles are operated to allow a plurality of people to ride together according to a schedule that varies depending on users' requests, instead of a fixed schedule. For example, a demand responsive transport system receives a reservation specifying a pick-up location, a drop-off location, a desired time period, and others from each user, and determines time periods for operating vehicles, the number of vehicles, traveling routes, and others according to the received reservations. Such demand responsive transport systems may be introduced in order to cover areas that are not covered by existing public transportation systems. In addition, the demand responsive transport systems may be used in areas where it is difficult to keep trains or route buses operating according to fixed schedules and fixed traveling routes due to a population decline or a profitability decline.

For the demand responsive transport systems, there is proposed a system for supporting users during a reservation procedure. This system detects a periodic transport pattern of each user from the reservation history of the user, and offers the user the next reservation on the basis of the detected transport pattern. In addition, the system detects other users who have similar travel patterns to a particular user in terms of drop-off locations, time periods, or another, and encourages the user to travel to locations where the user has never gotten off before and the other users having the similar travel patterns often got off, as new destinations.

Further, there is also proposed a node insertion algorithm as a method of determining a traveling route in a demand responsive transport system. In this algorithm, when new pick-up and drop-off locations are requested by a user, the new locations are added to the current traveling route such as to provide the shortest traveling route.

Still further, there is proposed a scheduling system in which users are allocated to a plurality of rideshare vehicles. In the case where a group of users who desire different pick-up locations or different drop-off locations would like to ride together in the same vehicle, this scheduling system allocates this group to a single vehicle, and enables all of the users in the group to gather together by preparing other vehicles as transfer vehicles to carry some of the users in the group from their pick-up locations or to their drop-off locations. Still further, there is proposed a vehicle allocation system for allowing a plurality of patients to share a taxi when the patients go home from a medical facility. This vehicle allocation system detects a combination of patients who have the same consultation time period and whose residential areas are close to each other, from patients who want rideshare, and requests a taxi company to send a taxi to the medical facility at a time based on the consultation time period for the detected combination of patients.

Please see, for example, Japanese Laid-open Patent Publications Nos. 2002-342873 and 2003-216727.

Please also see, for example, “Joint Development of Enhanced Demand Responsive Transport System by the University of Tokyo and IBM Japan, Operation Starts This Mon th in Tamaki-cho in Mie Prefecture” National University Corporation, the University of Tokyo, and IBM Japan, Ltd., [online], Nov. 21, 2011, [Search on Jun. 4, 2014], the Internet <URL:www.k.u-tokyo.ac.jp/news/20111121press.htm 1>.

Please also see, for example, “Proposal for Route Search Algorithm for Dial-a-Ride System”, Shuichiro Yamaguchi, Ryuji Maeda, and Keiichi Uchimura, Proceedings of 17th Kumamoto Prefecture Industry-Academia-Government Technology Meeting 104, Jan. 21, 2003.

In areas where demand responsive transport systems are operated, profits to cover operating expenses may not be gained because the number of passengers or the vehicle occupancy per vehicle is low. Therefore, it is preferable that such systems stimulate users' potential demands or encourage a plurality of users to take the same vehicle trip, if possible, not to take different vehicle trips on different departure dates and times.

However, the technique described in the above reference, “Joint Development of Enhanced Demand Responsive Transport System by the University of Tokyo and IBM Japan, Operation Starts This Month in Tamaki-cho in Mie Prefecture”, merely offers users destinations, and therefore may not strongly motivate the users to go out. In addition, since users who are offered consider whether to go out or not, independently of other users, the users may request different dates and times, which does not contribute to improving the vehicle occupancy. Furthermore, the technique described in Japanese Laid-open Patent Publication No. 2002-342873 is based on the premise that there is a group of users who would like to ride together, and this technique does not make an attempt to create such a group. On the other hand, the technique described in Japanese Laid-open Patent Publication No. 2003-216727 is based on the premise that there is a plurality of users who are planning to get on a vehicle at the same location in the same time period, and this technique does not make an attempt to increase the number of such users.

### SUMMARY

According to one aspect, there is provided a reservation management method including: obtaining, by a processor, reservation information including reserved trip information and reserving user information, the reserved trip information indicating a first vehicle trip that has not departed and is reserved by a user of a plurality of users, the reserving user information indicating the user; determining, by the processor, with reference to history information associating information about users who took individual ones of a plurality of second vehicle trips that were operated with different departure dates and times in a past among the plurality of users with trip information indicating the individual second vehicle trips, one or more other users each associated with same trip information as the user from the plurality of users; and outputting, by the processor, other user information indicating some or all of the determined one or more other users in association with the reservation information.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates a reservation management apparatus according to a first embodiment;

FIG. 2 illustrates an information processing system according to a second embodiment;

FIG. 3 illustrates an example of a user interface for a reserving user;

FIG. 4 illustrates an example of a user interface for a co-passenger candidate;

FIG. 5 is a block diagram illustrating an example of hardware of a reservation management server;

FIG. 6 is a block diagram illustrating an example of hardware of a user terminal;

FIG. 7 is a block diagram illustrating functions of the reservation management server and the user terminal;

FIG. 8 illustrates an example of a user table, a location table, and a vehicle table;

FIG. 9 illustrates an example of operation schedule information;

FIG. 10 illustrates an example of operation record information;

FIG. 11 illustrates an example of a passenger table and a rideshare aggregation table;

FIG. 12 illustrates an example of messages between a reserving user and the reservation management server;

FIG. 13 illustrates an example of messages communicated between the reservation management server and a co-passenger candidate;

FIG. 14 is a flowchart illustrating an example of a procedure for a process that is performed by a reserving user's terminal;

FIG. 15 is a flowchart illustrating a procedure for a process to be performed by a co-passenger's terminal; and

FIG. 16 is a flowchart illustrating a procedure for a process performed by the reservation management server.

### DESCRIPTION OF EMBODIMENTS

Several embodiments will be described below with reference to the accompanying drawings, wherein like reference numerals refer to like elements throughout.

### First Embodiment

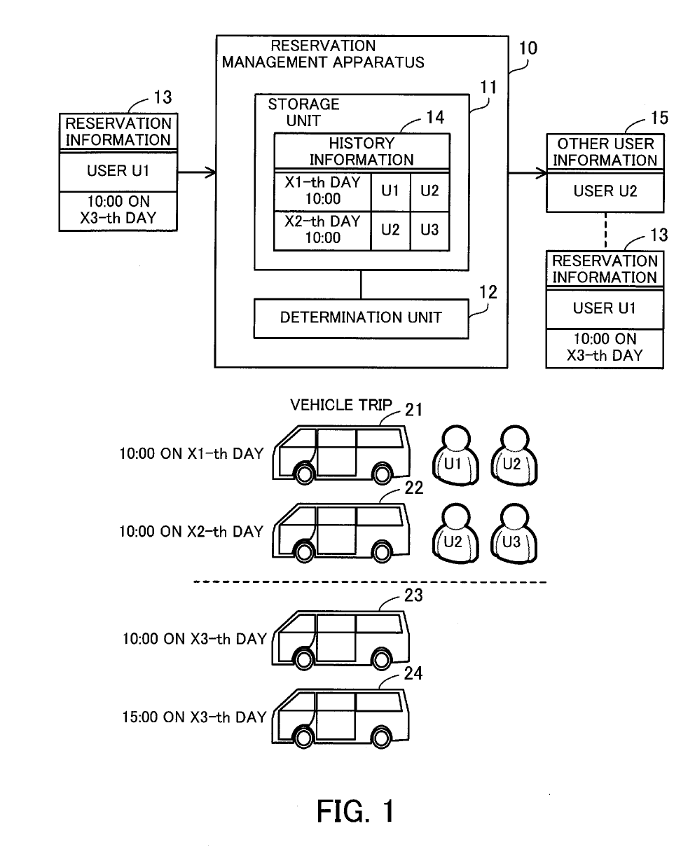

FIG. 1 illustrates a reservation management apparatus according to a first embodiment.

A reservation management apparatus 10 of the first embodiment manages reservations in a demand responsive transport system. This transportation system operates a plurality of vehicle trips scheduled at different departure dates and times (at least one of the departure date and the departure time is different), according to reservations from users. For example, when there is at least one reservation made for a certain departure date and time from a user by a reservation deadline, a vehicle runs. When there is no reservation made, on the other hand, any vehicle does not run. For each of the plurality of vehicle trips, a bus, a taxi, or another vehicle that is able to run on roads and allows two or more users to ride together is used. The same vehicle or different vehicles may be used for a plurality of vehicle trips. Users select desired vehicle trips and make reservations before riding on vehicles. For example, the reservation management apparatus 10 accepts the reservations from user terminals over a network. Alternatively, operators may verbally accept reservations from the users and enter the details of the reservations in the reservation management apparatus 10.

The reservation management apparatus 10 includes a storage unit 11 and a determination unit 12. The reservation management apparatus 10 may be implemented by using a computer. For example, the storage unit 11 may be a volatile memory, such as a Random Access Memory (RAM), etc., or a non-volatile storage device, such as a Hard Disk Drive (HDD), a flash memory, etc. The determination unit 12 may be a Central Processing Unit (CPU), a Digital Signal Processor (DSP), or another processor. The determination unit 12 may include an Application Specific Integrated Circuit (ASIC), a Field Programmable Gate Array (FPGA), or another application specific electronic circuit. The processor executes programs stored in a RAM or another memory. A set of plural processors (multiprocessor) may be called “a processor”.

The storage unit 11 stores history information 14. The history information 14 includes trip information indicating a plurality of past vehicle trips (a plurality of second vehicle trips), which were operated in the past. The history information 14 also includes, in association with the trip information, information about users who took the second vehicle trips indicated by the trip information among a plurality of users. The plurality of second vehicle trips includes vehicle trips 21 and 22. The plurality of users includes users U1, U2, and U3. For example, assume that the users U1 and U2 took the vehicle trip 21 that departed at 10:00 on the X1-th day, and the users U2 and U3 took the vehicle trip 22 that departed at 10:00 on the X2-th day. In the case where there are two or more drop-off locations, the history information 14 may further include drop-off location information indicating the drop-off locations of the users U1, U2, and U3.

The determination unit 12 obtains reservation information 13. The reservation information 13 includes reserved trip information indicating a first vehicle trip reserved by a user among one or more vehicle trips (one or more first vehicle trips) that have not departed. The reservation information 13 also includes reserving user information indicating the user who made the reservation. For example, assume that, while a vehicle trip 23 scheduled for departure at 10:00 on the X3-th day and a vehicle trip 24 scheduled for departure at 15:00 on the X3-th day are available, the user U1 makes a reservation for the vehicle trip 23. The reservation information 13 may be obtained over a network from a user terminal used by the user making the reservation. Alternatively, the reservation information 13 may be entered by an operator, or may be extracted from a database containing the details of reservations after the reservation is completed.

After obtaining the reservation information 13, the determination unit 12 determines one or more other users who took the same second vehicle trip as the user who made the reservation. To recognize relationship between users, the determination unit 12 refers to the history information 14 stored in the storage unit 11 in order to determine other users who are associated with the same trip information as a particular user. For example, assume that the history information 14 associates the information about the users U1 and U2 with the trip information indicating the vehicle trip 21 and associates the information about the users U2 and U3 with the trip information indicating the vehicle trip 22. In this case, the determination unit 12 determines that the user U1 and the user U2 took the same second vehicle trip in the past, with reference to the history information 14. In the case where the history information 14 includes drop-off location information, the determination unit 12 may determine one or more other users who got off at the same location in the same second vehicle trip as a particular user.

Such other users to be determined are limited to ones who frequently took the same second vehicle trip as a particular user or ones who frequently got off at the same location in the same second vehicle trip as the user (for example, the number of times that has happened is greater than or equal to a threshold). In this connection, before obtaining the reservation information 13, the determination unit 12 may determine combinations of users who took the same second vehicle trip or combinations of users who frequently took the same second vehicle trip.

After determining one or more other users, the determination unit 12 outputs other user information 15 indicating at least some of the determined other users in association with the reservation information 13. For example, the reservation information 13 indicates that the user U1 made a reservation for the vehicle trip 23 scheduled for departure at 10:00 on the X3-th day, and the other user information 15 associated with the reservation information 13 indicates the user U2. There is a possibility that other users indicated by the other user information 15 want to take the same first vehicle trip as the user who made the reservation, and therefore there is an idea of offering the other users to take the same first vehicle trip as the user reserved.

For example, the determination unit 12 may send a message giving an offer of the first vehicle trip indicated by the reservation information 13 to the addresses (for example, electronic mail addresses, Internet Protocol (IP) addresses, or the like) of the other users indicated by the other user information 15. Alternatively, operators may call the other users to verbally offer them to take the first vehicle trip.

According to the first embodiment, when the user U1 makes a reservation for the vehicle trip 23, the reservation management apparatus 10 determines the user U2 who took the same vehicle trip as the user U1 (or who got off at the same location in the same vehicle trip as the user U1). Then, the reservation management apparatus 10 outputs the other user information 15 indicating the user U2 in association with the reservation information 13. For example, the vehicle trip 23 is offered to the user U2. There is a possibility that the user U2 is one of user U1's friends and acquaintances. In the way described above, by analyzing the human relationship between users on the basis of the history information 14 and giving an offer of the same vehicle trip 23 as the user U1 on the basis of the human relationship, it is possible to lower the psychological barrier of the user U2 who received the offer and to increase the possibility that the user U2 takes the same vehicle trip 23 as the user U1.

As a result, the number of passengers or the vehicle occupancy is increased. For example, there is a possibility that such an offer stimulates the potential demand of the user U2, and thus an aggregate demand for the demand responsive transport system may be increased. In addition, such an offer increases the possibility that the users U1 and U2 take the same vehicle trip 23 while reducing the possibility that the users U1 and U2 make reservations for different vehicle trips, which leads to facilitating the efficient operation of the demand responsive transport system while decreasing the number of vehicle trips.

### Second Embodiment

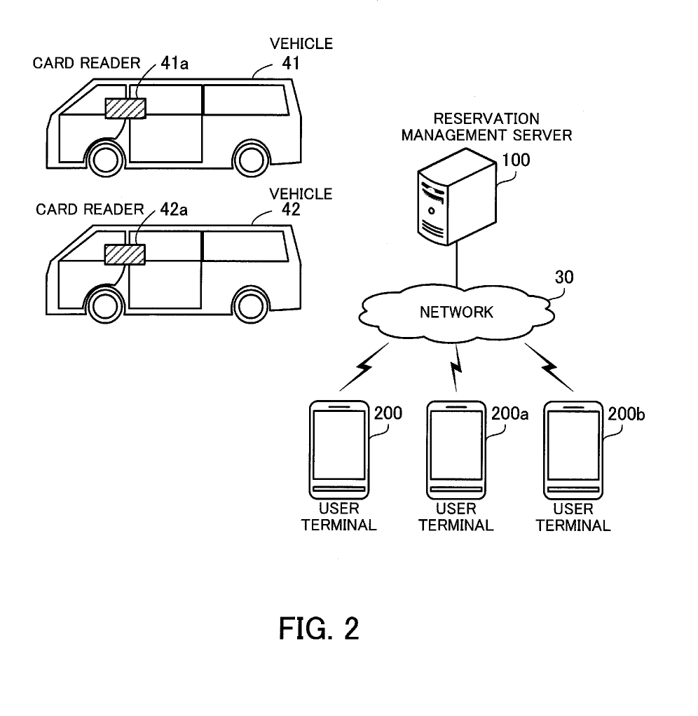

FIG. 2 illustrates an information processing system according to a second embodiment.

The information processing system of the second embodiment is used to manage a demand responsive transport system. The managed public transportation system operates a plurality of vehicles including vehicles 41 and 42 according not to a fixed schedule but to a schedule that varies according to user requests. The vehicles 41 and 42 are automobiles that allow a plurality of users to ride together. For example, minibuses and van taxis are the ones. This public transportation system is operated by a local government, a private business enterprise, or the like. In addition, in general, the public transportation system is used by users who have registered themselves as members of a community. Whether to operate the vehicles 41 and 42 in a certain time period and which routes the vehicles 41 and 42 run vary depending on reservations from users.

The information processing system that manages the public transportation system includes a reservation management server 100. The reservation management server 100 is a server computer connected to a network 30. The network 30 may include a wide-area data communication network, such as the Internet. The reservation management server 100 is able to receive reservation requests from user terminals 200, 200a, and 200b over the network 30. A reservation request specifies a user-desired time period, a pick-up location, and a drop-off location for a trip. The reservation management server 100 determines an operation schedule including vehicles to be operated, traveling routes, and so on for each time period according to the reservation requests. The reservation management server 100 notifies the driver of each vehicle of the determined operation schedule. For example, the reservation management server 100 sends the operation schedule to the drivers' terminals installed on the vehicles 41 and 42.

The user terminals 200, 200a, and 200b are terminal devices that are operated by users belonging to the community. The user terminals 200, 200a, and 200b may be mobile telephones, such as smartphone, etc., or mobile information terminals, such as Personal Digital Assistant (PDA), etc. Alternatively, the user terminals 200, 200a, and 200b may be client computers, such as tablet computers, notebook computers, laptop computers, etc. The user terminals 200, 200a, and 200b are able to access the reservation management server 100 over the network 30. At this time, the user terminals 200, 200a, and 200b may connect to base stations present in the network 30, via wireless links.

For example, each user terminal 200, 200a, and 200b may activate a Web browser and access the reservation management server 100 using Hyper Text Transfer Protocol (HTTP) according to user operations made on the Web browser. Further, for example, each user terminal 200, 200a, and 200b may download terminal software to be used for reservation management, run the terminal software, and communicate with the reservation management server 100. A user belonging to the community uses the user terminal 200, 200a, and 200b or a telephone to verbally make a reservation for a seat. In this case, an operator that receives the telephone call may enter the reservation request in the reservation management server 100.

The user carries with him/her an Integrated Circuit (IC) card in which his/her identification information is stored. A card reader 41a is installed in the vehicle 41. When getting on and off the vehicle 41, the user allows the card reader 41a to read the identification information from the user's IC card. The card reader 41a stores therein a card history indicating a pick-up location, a pick-up time, a drop-off location, a drop-off time, and others in association with the read identification information. Similarly, a card reader 42a is installed in the vehicle 42. When the vehicles arrive at a garage after completing their trips, the card readers 41a and 42a send the card histories to the reservation management server 100. Alternatively, the card readers 41a and 42a may send the card histories to the reservation management server 100 through radio communication on an as-needed basis. Thereby, the operation records of the vehicles 41 and 42 are accumulated in the reservation management server 100. If there are no IC cards or card readers, the operation records may be entered in the reservation management server 100 on the basis of the user entering and exiting state recognized by a driver.

The information processing system of the second embodiment has an offering function of giving a rideshare offer to other users different from the user who made a reservation for a seat, in order to increase the number of passengers or the vehicle occupancy of the vehicles 41 and 42. This offering function may stimulate the potential demand of the other users who received the offer and thereby increase an aggregate demand for the public transportation system. In addition, the offering function leads to having seat reservations made for the same time period, which may reduce the number of operations of the vehicles 41 and 42. The offering function uses connections (human relationship) between users to promote rideshare.

More specifically, the reservation management server 100 analyzes the operation records of the vehicles 41 and 42 to detect combinations of users who frequently took the same vehicle trip (the same vehicle in the same time period) to travel to the same location. When a user (for example, the user of the user terminal 200) makes a reservation for a seat of a certain vehicle trip, the reservation management server 100 offers other users (for example, the user of the user terminal 200a) that frequently rode together with the user, to make a reservation for a seat of the same vehicle trip.

In this connection, such a rideshare offer may be sent via an electronic mail from the reservation management server 100 to the user terminals 200, 200a and 200b. Alternatively, the user terminals 200, 200a, and 200b may be designed to keep on running the terminal software to periodically access the reservation management server 100 using the terminal software to inquire whether such a rideshare offer directed to the own user terminal has come or not.

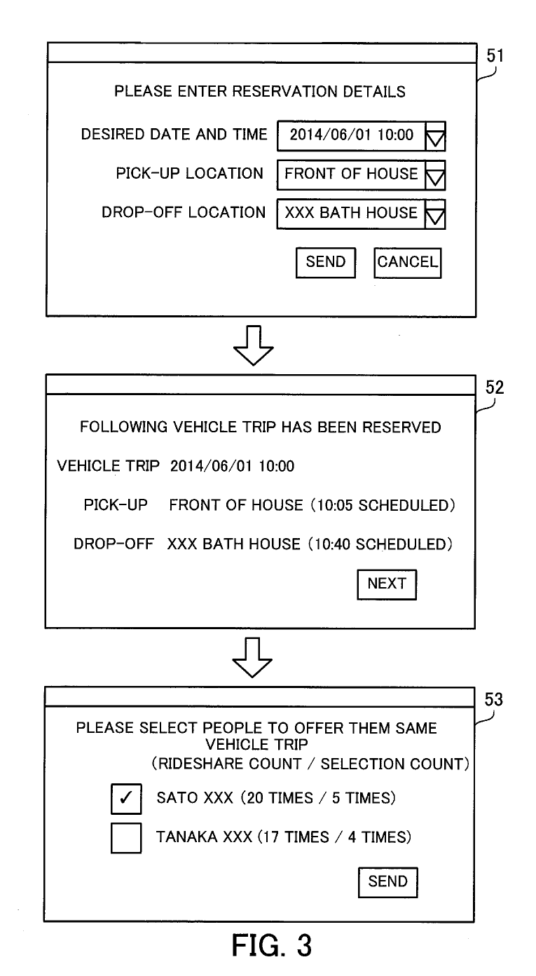

FIG. 3 illustrates a user interface for a reserving user.

The following describes the case where the user of the user terminal 200 makes a reservation for a seat.

A screen 51 is displayed on the display of the user terminal 200. The screen 51 is displayed, for example, when the user terminal 200 accesses the reservation management server 100 using a Web browser or runs terminal software. The screen 51 includes an input field for specifying a desired date and time, an input field for specifying a pick-up location, and an input field for specifying a drop-off location.

The desired date and time indicate which day and in which time period the user wants to use the public transportation system. For example, Jun. 1, 2014 between 10 and 11 o'clock is specified as the desired date and time. The desired date and time may be selected from a plurality of options. The pick-up location indicates at which location the user wants to get on a vehicle out of a plurality of previously designated available stop locations. The drop-off location indicates at which location the user wants to get off the vehicle out of the plurality of previously designated available stop locations. The pick-up and drop-off locations may be selected from a plurality of options. The user terminal 200 may receive information indicating the available stop locations from the reservation management server 100. In addition, the latitude and longitude of a user's house are registered in the user terminal 200. In the case where the current position measured by GPS indicates the position of the house, “front of house” may automatically be selected as an initial value of the pick-up location.

The user terminal 200 sends a reservation request including the desired date and time, the pick-up location, and the drop-off location, entered on the screen 51, to the reservation management server 100. The reservation management server 100 updates the operation schedule according to the reservation request, and sends a reservation result to the user terminal 200. If the reservation for a seat is fixed, a screen 52 is displayed on the display of the user terminal 200. The screen 52 displays information about a vehicle trip, a pick-up location, a pick-up time, a drop-off location, and a scheduled drop-off time as the reservation result.

The vehicle trip is a vehicle indicated by a combination of a date and a time period, and in primary, is determined by the desired date and time entered on the screen 51. In the case where a plurality of vehicle trips is available to a user's reservation request, one of the available vehicle trips is determined with a predetermined method (for example, a vehicle trip with more empty seats). The pick-up and drop-off locations displayed on the screen 52 are primarily the same as those entered on the screen 51. The pick-up time indicates when a vehicle for the vehicle trip arrives at the pick-up location, and is calculated by the reservation management server 100 from the current operation schedule. The scheduled drop-off time indicates when the vehicle will arrive at the drop-off location, and is estimated by the reservation management server 100 from the current operation schedule and the normal traffic congestion.

In addition, when the seat reservation is fixed, the reservation management server 100 sends the user terminal 200 a selection request including a list of other users (co-passenger candidates) that will possibly rideshare with the user of the user terminal 200. The co-passenger candidates are determined by the reservation management server 100 by analyzing the operation records of the vehicles 41 and 42, as described earlier. The co-passenger candidates are other users who frequently took the same vehicle trip as the user of the user terminal 200 to travel to the same location as the user, that is to say, who frequently got on the same vehicle in the same time period as the user and got off at the same drop-off location as the user. There is a high possibility that the obtained co-passenger candidates are friends of the user of the user terminal 200.

A screen 53 is displayed on the display of the user terminal 200. The screen 53 displays a list of the names of co-passenger candidates and an input field for selecting co-passenger candidates to give them a rideshare offer for the currently reserved vehicle trip. The screen 53 also displays, for each of the co-passenger candidates, a list of how many times the user got off at the same location in the same vehicle trip as the candidate in the past (rideshare count) and how many times the user selected the candidate on the screen 53 in the past (selection count). On the screen 53, the user of the user terminal 200 is able to select one or more co-passenger candidates. The user of the user terminal 200 may not select any co-passenger candidates. The user terminal 200 sends a selection notification of the selected co-passenger candidates to the reservation management server 100.

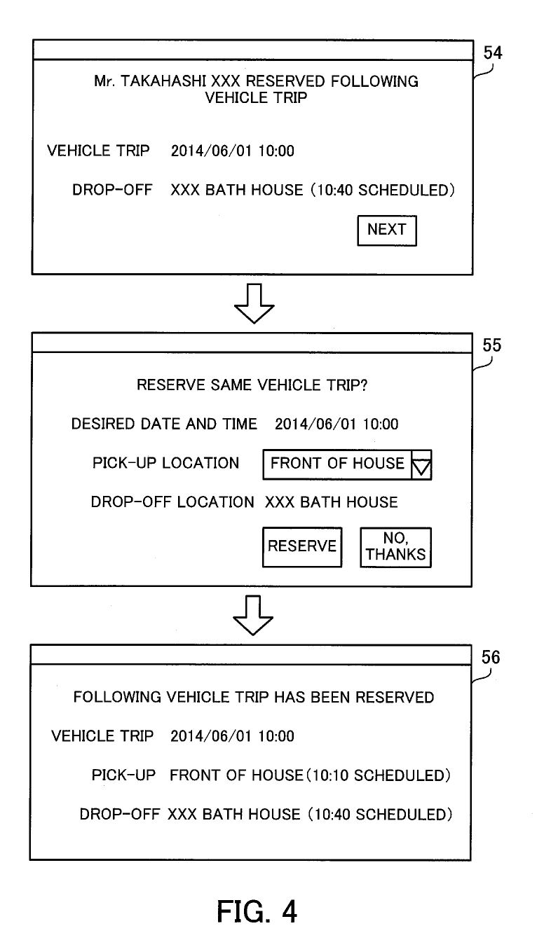

FIG. 4 illustrates an example of a user interface for a co-passenger candidate.

The following describes the case where the user of the user terminal 200a is a co-passenger candidate.

The user terminal 200a receives a rideshare offer from the reservation management server 100. To this end, the user terminal 200a uses a specific communication method, such as emails, polling using the terminal software, or the like, as described earlier. When receiving the rideshare offer, a screen 54 is displayed on the display of the user terminal 200a. The screen 54 includes information including the name of a reserving user, a reserved vehicle trip, a drop-off location, and a scheduled drop-off time.

After the screen 54, a screen 55 is displayed on the display of the user terminal 200a. The screen 55 displays information indicating a desired date and time and a drop-off location, and an input field for specifying a pick-up location. When the user of the user terminal 200a wants rideshare, the desired date and time and drop-off location are previously entered because the vehicle trip and drop-off location are the same as those of the user of the user terminal 200. Similarly to the screen 51, the pick-up location may be selected from a plurality of options. In this connection, the latitude and longitude of the house of the user of the user terminal 200a is registered in the user terminal 200a. In the case where the current position measured by GPS indicates the position of the house, “front of house” is automatically selected as an initial value of the pick-up location.

The user terminal 200a sends the reservation management server 100 a reservation request including the pick-up location entered on the screen 55. The reservation management server 100 updates the operation schedule according to the reservation request, and returns a reservation result to the user terminal 200a. When the seat reservation is fixed, a screen 56 is displayed on the display of the user terminal 200a. The screen 56 displays information about the vehicle trip, the pick-up location, the pick-up time, the drop-off location, and a scheduled drop-off time, as the reservation result. On the other hand, in the case where the user of the user terminal 200a views the screen 55 and does not want rideshare, a reservation request is not sent from the user terminal 200a to the reservation management server 100 and the screen 56 is not displayed.

The following describes the hardware configurations of the reservation management server 100 and the user terminal 200.

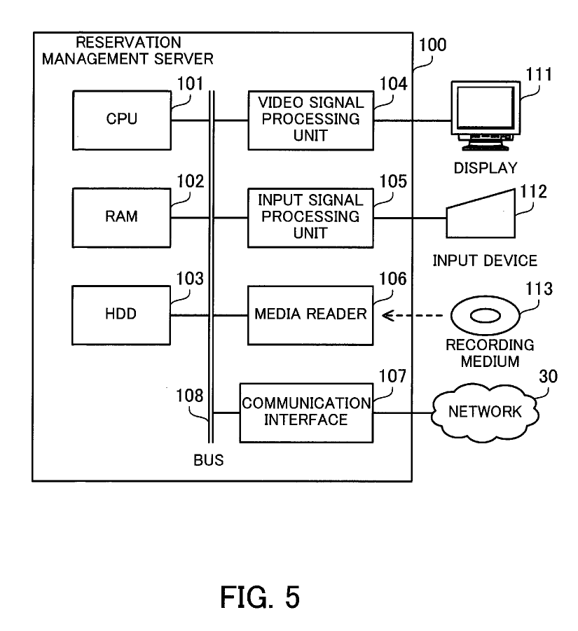

FIG. 5 is a block diagram illustrating an example of hardware of a reservation management server.

The reservation management server 100 includes a CPU 101, a RAM 102, a HDD 103, a video signal processing unit 104, an input signal processing unit 105, a media reader 106, and a communication interface 107. These units are connected to a bus 108.

The CPU 101 is a processor including a computing circuit for executing instructions described in programs. The CPU 101 loads at least part of programs and data from the HDD 103 to the RAM 102 and executes the programs. The CPU 101 may be provided with a plurality of processor cores. The reservation management server 100 may perform processes, which will be described later, in parallel using a plurality of processors or processor cores. A set of plural processors (multiprocessor) may be called “a processor”.

The RAM 102 is a volatile semiconductor memory that temporarily stores therein programs to be executed by the CPU 101 and data to be used in processing of the CPU 101. In this connection, the reservation management server 100 may be provided with another type of memory or a plurality of memories.

The HDD 103 is a non-volatile storage device that stores therein software programs, such as Operating System (OS) programs, middleware programs, application software programs, and data. The programs include a reservation management program for managing vehicle reservations. The reservation management server 100 may be provided with another type of storage device, such as a flash memory, Solid State Drive (SSD), etc., or a plurality of non-volatile storage devices.

The video signal processing unit 104 outputs images to a display 111 connected to the reservation management server 100 in accordance with instructions from the CPU 101. As the display 111, a Cathode Ray Tube (CRT) display, a liquid crystal display (LCD), a Plasma Display Panel (PDP) display, an Organic Electro-Luminescence (OEL) display, etc., may be used.

The input signal processing unit 105 receives input signals from an input device 112 connected to the reservation management server 100 and outputs them to the CPU 101. As the input device 112, a pointing device, such as a mouse, a touch panel, a touchpad, a track ball, etc., a keyboard, a remote controller, a button switch, etc. may be used. In addition, plural types of input devices may be connected to the reservation management server 100.

The media reader 106 is a device that reads and writes programs and data on a recording medium 113. As the recording medium 13, a magnetic disk, such as a flexible disk (FD), a HDD, etc., an optical disc, such as a Compact Disc (CD), a Digital Versatile Disc (DVD), etc., a Magneto-Optical disk (MO), a semiconductor memory, etc., may be used. For example, the media reader 106 loads programs and data from the recording medium 113 to the RAM 102 or the HDD 103.

The communication interface 107 is connected to the network 30 and performs communication with the user terminals 200, 200a, and 200b. The communication interface 107 may be a wired communication interface, which is connected to a switch or another communication device with a cable, or a wireless communication interface, which is connected to a base station or an access point via a wireless link.

In this connection, the reservation management server 100 may be configured without the media reader 106. In addition, the reservation management server 100 may be configured without the video signal processing unit 104 or the input signal processing unit 105 if it is controllable from a terminal device operated by a user. Furthermore, the display 111 and input device 112 may be integrally formed with the case of the reservation management server 100.

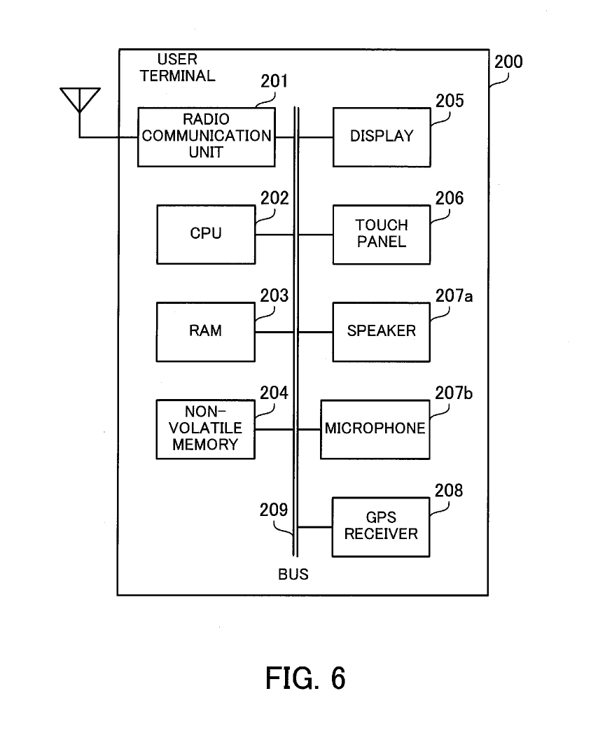

FIG. 6 is a block diagram illustrating an example of hardware of a user terminal.

The user terminal 200 includes a radio communication unit 201, a CPU 202, a RAM 203, a non-volatile memory 204, a display 205, a touch panel 206, a speaker 207a, a microphone 207b, and a GPS receiver 208. These units are connected to a bus 209. The user terminals 200a and 200b may be configured with the same hardware.

The radio communication unit 201 is a radio communication interface that performs radio communication with a base station or an access point that belongs to the network 30, via a wireless link. The radio communication unit 201 is able to communicate with the reservation management server 100 via a base station or an access point. A radio communication standard with which the radio communication unit 201 complies is, for example, a Wideband-Code Division Multiple Access (W-CDMA), Long Term Evolution (LTE), Institute of Electrical and Electronics Engineers (IEEE) 802.11, etc. The user terminal 200 may be provided with a wired communication interface to be connected to a communication device via a cable, in place of or together with the radio communication unit 201.

Similarly to the CPU 101 of the reservation management server 100, the CPU 202 is a processor including a computing circuit for executing instructions described in programs. Similarly to the RAM 102 of the reservation management server 100, the RAM 203 is a volatile semiconductor memory for temporarily storing programs to be executed by the CPU 202 and data to be used in processing of the CPU 202.

The non-volatile memory 204 is a non-volatile storage device for storing various kinds of software programs and data. As the non-volatile memory 204, a flash memory or an SSD may be used, for example. The stored programs may include application programs for reserving vehicles in collaboration with the reservation management server 100. In this connection, the user terminal 200 may be provided with another kind of storage device, such as a HDD.

Similarly to the display 111 of the reservation management server 100, the display 205 displays images, such as an operation screen, etc., in accordance with instructions from the CPU 202. As the display 205, for example, an LCD, an organic EL display, or the like may be used. The above-described screens 51 to 56 may be displayed on the display 205.

The touch panel 206 is an input device for accepting user inputs. The touch panel 206 is placed on the display 205. The touch panel 206 senses user touch operations made on a screen displayed on the display 205, and notifies the CPU 202 of the touch positions. For detecting a touch position, the resistive sensing technology, the capacitive sensing technology, or another desired technology may be used. In this connection, the user terminal 200 may be provided with another input device, such as a keypad, in place of or together with the touch panel 206.

The speaker 207a obtains an electrical signal as an audio signal from the CPU 202, coverts the obtained signal into physical vibrations, and outputs sounds. For example, while a user is talking with another user, the voice of the other user and the background noise are reproduced. The microphone 207b converts the physical vibrations of the sounds into an electrical signal, and outputs the electrical signal as an audio signal to the CPU 202. For example, while the user is talking with another user, the voice of the user and the background noise are entered from the microphone 207b.

The GPS receiver 208 receives GPS signals from a plurality of Global Positioning Systems (GPS) satellites, and calculates the current position of the user terminal 200 using the received GPS signals. A GPS signal includes a time when the GPS satellite sent the GPS signal. The current position is calculated based on a difference in propagation time of GPS signal among the plurality of GPS satellites. The current position is represented in latitude, longitude, and altitude.

The following describes the functions of the reservation management server 100 and user terminal 200.

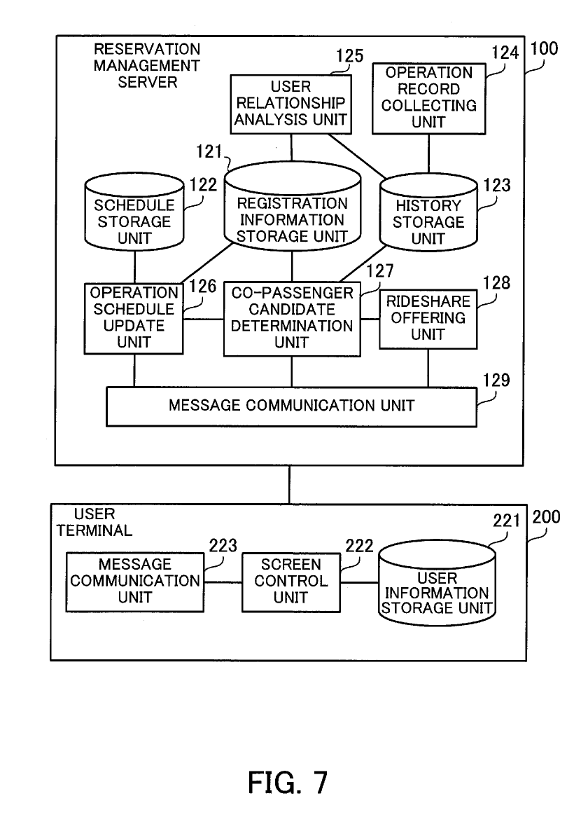

FIG. 7 is a block diagram illustrating functions of the reservation management server and the user terminal.

The reservation management server 100 includes a registration information storage unit 121, a schedule storage unit 122, a history storage unit 123, an operation record collecting unit 124, a user relationship analysis unit 125, an operation schedule update unit 126, a co-passenger candidate determination unit 127, a rideshare offering unit 128, and a message communication unit 129.

The registration information storage unit 121, the schedule storage unit 122, and the history storage unit 123 are implemented by using a storage area prepared in the RAM 102 or the HDD 103, for example. However, the data in the registration information storage unit 121, the schedule storage unit 122, and the history storage unit 123 may be stored in a storage device external to the reservation management server 100. The operation record collecting unit 124, the user relationship analysis unit 125, the operation schedule update unit 126, the co-passenger candidate determination unit 127, the rideshare offering unit 128, and the message communication unit 129 are implemented as, for example, program modules to be executed by the CPU 101. However, some or all of the operation record collecting unit 124, the user relationship analysis unit 125, the operation schedule update unit 126, the co-passenger candidate determination unit 127, the rideshare offering unit 128, and the message communication unit 129 may be implemented by using dedicated electronic circuits.

The registration information storage unit 121 stores therein information previously registered by users or operators. The registered information in the registration information storage unit 121 includes user information indicating the name of users and others, location information indicating available stop locations, and vehicle information indicating the number of seats available in each vehicle and others.

The schedule storage unit 122 stores therein an operation schedule of each vehicle trip. The operation schedule includes information indicating a vehicle to be operated, stop locations, scheduled arrival dates and times, entering and exiting passengers at each stop location, and others. The operation schedule is occasionally updated by the operation schedule update unit 126 in accordance with reservation requests received from the user terminals 200, 200a, and 200b.

The history storage unit 123 stores therein the operation records of the vehicles 41 and 42. Each operation record corresponds to an operation schedule and includes information indicating an operated vehicle, stop locations, arrival dates and times, entering and exiting passengers at each stop location, and others. The operation records may be collected by the operation record collecting unit 124 from the card readers 41a and 42a. Alternatively, the operation records may be entered manually by drivers or operators. The history storage unit 123 stores therein rideshare aggregation information that indicates the frequency that one user and another user got off at the same location in the same vehicle trip. The rideshare aggregation information is generated by analyzing the operation records of a plurality of vehicle trips.

The operation record collecting unit 124 may receive the operation records from the card readers 41a and 42a, when the vehicles 41 and 42 arrive at a garage or on an as-needed basis while the vehicles 41 and 42 run. In this case, the operation records are generated by the card readers 41a and 42a reading the identification information from IC cards when users get on and off vehicles. The operation record collecting unit 124 stores the operation records received from the card readers 41a and 42a in the history storage unit 123. In addition, the operation record collecting unit 124 may accept the passenger entering and exiting state recognized by drivers and entered by the drivers or operators. In this case, the operation record collecting unit 124 generates operation records according to the entered information and stores them in the history storage unit 123.

The user relationship analysis unit 125 analyzes the operation records of the plurality of vehicle trips, stored in the history storage unit 123, with reference to the user information and location information stored in the registration information storage unit 121. The user relationship analysis unit 125 generates rideshare aggregation information indicating the frequency that one user and another user got off at the same location in the same vehicle trip (rideshare frequency), and stores the rideshare aggregation information in the history storage unit 123. It is preferable that the user relationship analysis unit 125 calculates the rideshare frequency for each of various combinations of users intermittently (periodically or non-periodically). Alternatively, when any user makes a reservation for a seat, the user relationship analysis unit 125 may calculate the rideshare frequency between the user who made the reservation and another user in real-time.

The operation schedule update unit 126 receives reservation requests from the user terminals 200, 200a, and 200b via the message communication unit 129. Then, the operation schedule update unit 126 determines whether or not the vehicle of a user-desired vehicle trip has any empty seat available in the zone indicated by a reservation request, with reference to the vehicle information stored in the registration information storage unit 121 and the operation schedule stored in the schedule storage unit 122. In the case where there is an empty seat available, the operation schedule update unit 126 fixes the seat reservation in response to the reservation request. That is, the operation schedule update unit 126 computes the traveling route so as to include the pick-up and drop-off locations specified by the reservation request, and updates the operation schedule stored in the schedule storage unit 122.

As a method of computing a traveling route, for example, the node insertion method described in the following document may be used: “Proposal for Route Search Algorithm for Dial-a-Ride System”, Shuichiro Yamaguchi, Ryuji Maeda, and Keiichi Uchimura, Proceedings of 17th Kumamoto Prefecture Industry-Academia-Government Technology Meeting 104. In this node insertion method, stop locations are represented as nodes, and a traveling route is represented as a series of nodes. The start point (origin location) and end point (destination location) of the traveling route are previously set. In the case where new pick-up and drop-off locations are added to the current traveling route, new nodes corresponding to the respective pick-up and drop-off locations are inserted in appropriate zones of the current series of nodes such as to produce the shortest traveling route.

In the case where the seat reservation is fixed, the operation schedule update unit 126 returns a reservation result indicating the vehicle trip, the pick-up date and time, the scheduled drop-off date and time, and others via the message communication unit 129. In the case where the seat reservation is rejected because of no empty seats available or another reason, the operation schedule update unit 126 returns a reservation result indicating the rejection of the reservation. In addition, in the case where the seat reservation is fixed, the operation schedule update unit 126 further determines whether there is any other empty seat available in the reserved vehicle trip, and then notifies the co-passenger candidate determination unit 127 of the reservation result and the number of empty seats so as to give an rideshare offer to other users.

The co-passenger candidate determination unit 127 determines co-passenger candidates with reference to the user information and location information stored in the registration information storage unit 121 and the rideshare aggregation information stored in the history storage unit 123. The co-passenger candidates are other users who have high rideshare frequencies of rideshare with the user who made the reservation. The co-passenger candidate determination unit 127 sends a selection request including a list of the determined co-passenger candidates to the user terminal that have sent the reservation request, via the message communication unit 129. In the case where there are no more empty seats available, on the other hand, a selection request indicating no co-passenger candidates is sent. Then, the co-passenger candidate determination unit 127 receives a selection notification via the message communication unit 129. The co-passenger candidate determination unit 127 notifies the rideshare offering unit 128 of the information indicating selected co-passenger candidates and the reservation result.

The rideshare offering unit 128 sends a rideshare offer indicating a proposer, a vehicle trip, a drop-off location, and a scheduled drop-off date and time to the user terminal used by each co-passenger candidate specified from the co-passenger candidate determination unit 127. The proposer is a reserving person who selected the co-passenger candidate. The rideshare offer may be sent via, for example, an electronic mail. In this case, the user information stored in the registration information storage unit 121 includes the electronic mail address of each user. In addition, the rideshare offer may be sent when the user terminal of the co-passenger candidate accesses the reservation management server 100 by polling. In this connection, the reservation request sent from the co-passenger candidate in response to the rideshare offer is received by the operation schedule update unit 126.

The message communication unit 129 transmits and receives various types of messages with the user terminals 200, 200a, and 200b. The message communication unit 129 outputs a received reservation request to the operation schedule update unit 126, and sends a reservation result generated by the operation schedule update unit 126. In addition, the message communication unit 129 sends a selection request generated by the co-passenger candidate determination unit 127, and outputs a received selection notification to the co-passenger candidate determination unit 127. The message communication unit 129 also sends a rideshare offer generated by the rideshare offering unit 128. The types of such messages may be described in detail later.

The user terminal 200 includes a user information storage unit 221, a screen control unit 222, and a message communication unit 223. The user information storage unit 221 is implemented by using, for example, a storage area prepared in the RAM 203 or the non-volatile memory 204. The screen control unit 222 and the message communication unit 223 are implemented as, for example, program modules to be executed by the CPU 202. The user terminals 200a and 200b are implemented with the same module configuration.

The user information storage unit 221 stores therein the identification information (user ID) of a user using the user terminal 200. The user information storage unit 221 also stores therein positional information indicating the position of the house of the user using the user terminal 200. The position of the house is to be compared with the current position measured by the GPS receiver 208, and is represented in latitude and longitude. The user ID and positional information are previously stored in the user information storage unit 221 according to user operation.

The screen control unit 222 controls screens to be displayed on the display 205. The screen control unit 222 may be implemented by using a Web browser or dedicated terminal software. When the user wants to make a reservation for a seat, the screen control unit 222 displays the screen 51 for entering the details of the reservation, on the display 205. At this time, the screen control unit 222 may obtain information indicating options for pick-up and drop-off locations from the reservation management server 100. The screen control unit 222 generates a reservation request according to user inputs made on the screen 51.

When receiving a reservation result to the reservation request, the screen control unit 222 displays the screen 52 displaying the details of the reservation on the display 205. Then, when obtaining a selection request, the screen control unit 222 displays the screen 53 for selecting other users to give them a rideshare offer, on the display 205. The screen control unit 222 generates a selection notification according to user selection made on the screen 53.

In addition, when another user makes a reservation for a seat, the screen control unit 222 may receive a rideshare offer. Then, the screen control unit 222 displays the screen 54 indicating the details of the other user's reservation, on the display 205, and when the rideshare offer is accepted, displays the screen 55 for entering the details of the reservation on the display 205. The screen control unit 222 generates a rideshare reservation request in accordance with the user inputs made on the screen 55. When obtaining a reservation result to the rideshare reservation request, the screen control unit 222 displays the screen 56 indicating the details of the reservation on the display 205.

The message communication unit 223 transmits and receives various types of messages with the reservation management server 100. The message communication unit 223 sends a reservation request generated by the screen control unit 222, and outputs a received reservation result to the screen control unit 222. In addition, the message communication unit 223 outputs a received selection request to the screen control unit 222, and sends a selection notification generated by the screen control unit 222. In addition, the message communication unit 223 gives a received rideshare offer to the screen control unit 222.

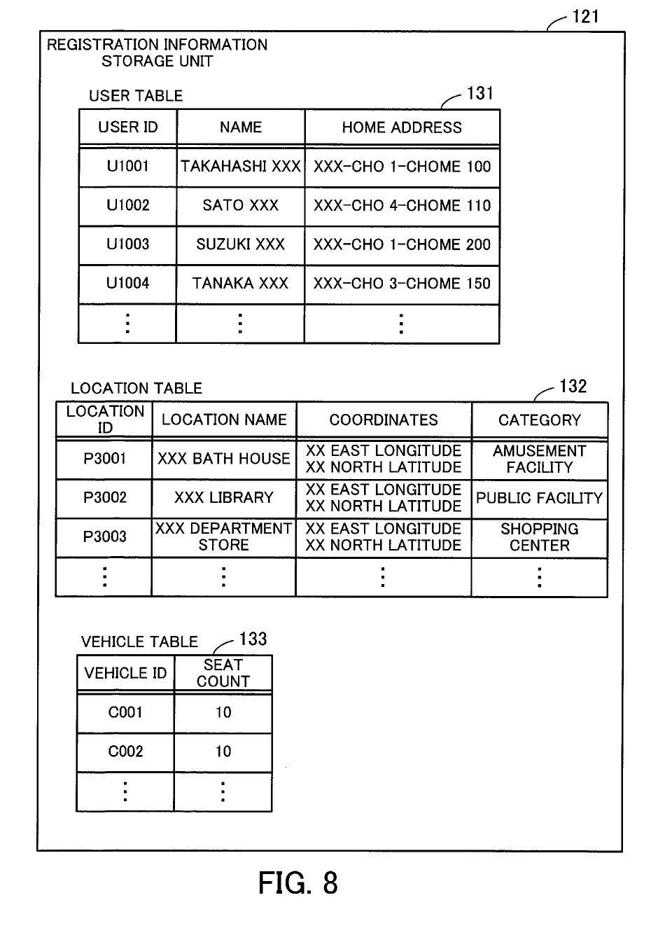

FIG. 8 illustrates an example of a user table, a location table, and a vehicle table.

The user table 131 is stored in the registration information storage unit 121. In the user table 131, users who have used the public transportation system are registered. The user table 131 includes the following fields: user ID, name, and home address. The user ID is identification information given to a user by the reservation management server 100 at the time of user registration. The name and home address are the name of the user and the home address which the user registered at the time of the user registration.

The location table 132 is stored in the registration information storage unit 121. The location table 132 registers therein the available stop locations of the vehicles 41 and 42, which are selectable as users' pick-up and drop-off locations. The location table 132 includes the following fields: location ID, location name, coordinates, and category. The location ID is identification information identifying a location. The location name is a name that represents the features of the location and is easy for users to recognize. For example, the name of facility located in the vicinity of the location may be used. The coordinates are expressed in latitude and altitude to represent the position of the location. The category indicates the kind of a purpose for getting off at the location. For example, the type of the facility located in the vicinity of the location (for example, amusement facility, public facility, shopping center, etc.) may be used.

The vehicle table 133 is stored in the registration information storage unit 121. In the vehicle table 133, minibuses, van taxis, and other vehicles to be operated in the public transportation system are registered in advance. The vehicle table 133 includes the following fields: vehicle ID and seat count. The vehicle ID is identification information identifying a vehicle. The seat count indicates the number of seats available to users, and corresponds to the maximum number of passengers who are able to sit in the vehicle. In the second embodiment, when a reservation request is issued for a vehicle trip, the trip zone indicated by the reservation request and the trip zones indicated by the already fixed reservations are compared with each other to see if there is an overlap or not. If the number of overlaps (the number of reservations) reaches the maximum number of seats in at least part of the trip zone indicated by the reservation request, it is determined that there are no empty seats available in the zone of the vehicle trip, and the reservation request is rejected. However, allowing traveling by standing, more reservations than the maximum number of seats may be accepted. In this case, the maximum number of passengers may be registered in the vehicle table 133, in place of the number of seats, and reservations may be accepted until the number of reservations reaches the maximum number of passengers. A value indicating the maximum number of passengers may be calculated by adding a predetermined number to the maximum number of seats.

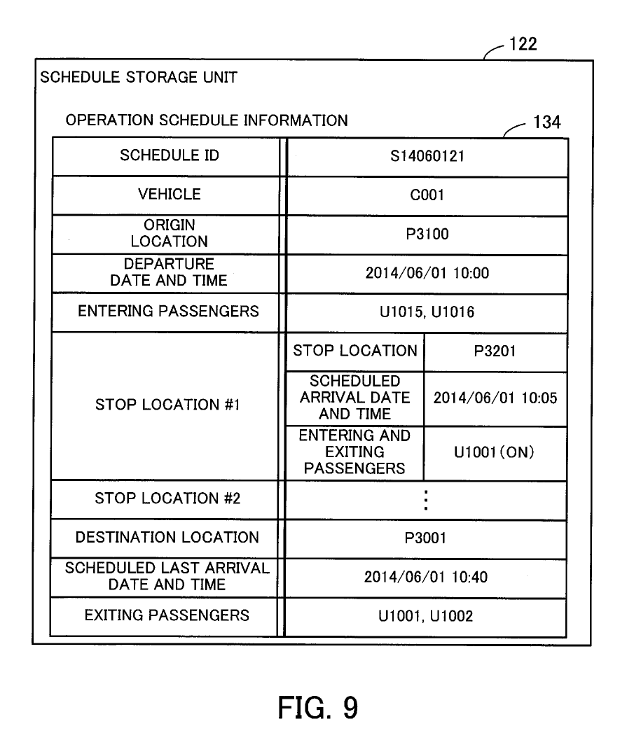

FIG. 9 illustrates an example of operation schedule information.

The operation schedule information 134 is generated for each vehicle trip by the operation schedule update unit 126, and is stored in the schedule storage unit 122. The operation schedule information 134 includes the following data items: schedule ID, vehicle, origin location, departure date and time, entering passengers, destination location, scheduled last arrival date and time, and exiting passengers. The operation schedule information 134 further includes, for each stop location, the following data fields: stop location, scheduled arrival date and time, and entering and exiting passengers.

The schedule ID is identification information identifying a vehicle trip that has not departed. The vehicle trip is indicated by a combination of a date, a time period, and a vehicle. The vehicle to be operated for the vehicle trip is represented using a vehicle ID registered in the vehicle table 133. The origin location is a location where the traveling route starts, and is represented using a location ID registered in the location table 132. The departure date and time indicate when the vehicle is scheduled to depart the origin location. The entering passengers are users who are scheduled to get on the vehicle at the origin location, and are represented using the user IDs registered in the user table 131.

The stop location is a location where the vehicle stops between the origin location and the destination location, and is represented using a location ID. The scheduled arrival date and time indicate when the vehicle is scheduled to arrive at the stop location. The entering and exiting passengers are users who are scheduled to get on or off the vehicle at the stop location, and are represented using user IDs. Entering users and exiting users are discriminated using flags. For example, a flag of 1 (ON) indicates that a user gets on the vehicle, whereas a flag of 0 (OFF) indicates that a user gets off the vehicle. In the case where there is a plurality of stop locations, these stop locations are arranged in order of stops, and a scheduled arrival date and time and entering and exiting passengers are registered for each stop location. The destination location indicates the last stop of the traveling route, and is represented using a location ID. The scheduled last arrival date and time indicate when the vehicle is scheduled to arrive at the destination location. The exiting passengers are users who are scheduled to get off at the destination location, and are represented using user IDs.

When a user makes a reservation for a seat, the operation schedule information 134 is updated. At this time, the user ID of the user is registered in association with the pick-up and drop-off locations of the user in the operation schedule information 134. According to this reservation, the traveling route may be changed by adding these new stop locations. The traveling route may be computed using the above-described node insertion algorithm or another algorithm. When the traveling route is changed, the scheduled arrival dates and times of the stop locations and the scheduled last arrival date and time may be changed accordingly. The scheduled arrival dates and times and scheduled last arrival date and time may be estimated based on a travel distance calculated based on map data and the normal traffic congestion of the traveling route.

In this connection, the reservation management server 100 may accept seat reservations by a prescribed time period (for example, 30 minutes) ahead of the departure date and time. For example, reservations for a vehicle trip between 10 and 11 o'clock are accepted by 9:30. Reservation requests made after the reservation deadline are rejected.

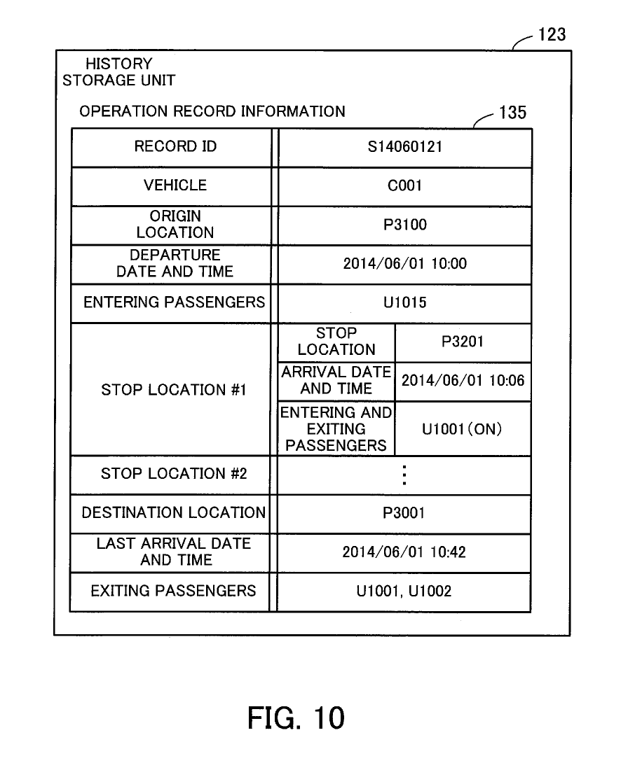

FIG. 10 illustrates an example of operation record information.

The operation record information 135 indicates the operation records of vehicle trips, and corresponds to the operation schedule information 134. The operation record information 135 is generated after a vehicle completes its trip according to the operation schedule information 134, and is stored in the history storage unit 123. The operation record information 135 includes the following data items: record ID, vehicle, origin location, departure date and time, entering passengers, destination location, last arrival date and time, and exiting passengers. The operation record information 135 also includes, for each stop location, the following data items: stop location, arrival date and time, and entering and exiting passengers.

The record ID is identification information identifying a past vehicle trip. A schedule ID registered in the operation schedule information 134 may be used as the record ID. The vehicle, origin location, stop locations, and destination location are the same as those registered in the operation schedule information 134. The departure date and time indicate when the vehicle departed the origin location. The entering passengers are users who got on the vehicle at the origin location, and are represented using user IDs registered in the user table 131. The arrival date and time indicate when the vehicle arrived at a stop location. The entering and exiting passengers are users who got on or off the vehicle at the stop location, and are represented using user IDs. The last arrival date and time indicate when the vehicle arrived at the destination location. The exiting passengers are users who got off the vehicle at the destination location, and are represented using user IDs.

The departure date and time and the last arrival date and time are recorded by, for example, a driver. The arrival date and time of each stop location is calculated based on the dates and times when the card reader 41a and 42a reads the identification information from IC cards. The entering passengers, the exiting passengers, and the entering and exiting passengers of each stop location are specified based on, for example, the identification information read by the card reader 41a and 42a from IC cards. Alternatively, the driver or operator may enter the departure date and time, entering passengers, the arrival date and time of each stop location, the entering and exiting passengers of each stop location, the last arrival date and time, and the exiting passengers according to the operation state recognized by the driver. Yet alternatively, a GPS receiver may be installed on each vehicle, GPS positional information and time information may be recorded in association with each other, and the departure date and time, the arrival date and time of each stop location, and the last arrival date and time may be calculated based on the records.

In this connection, the entering passengers, the exiting passengers, and the entering and exiting passengers of each stop location registered in the operation record information 135 are part or all of the users registered in the operation schedule information 134. In addition, the vehicle, origin location, stop locations, and destination location registered in the operation record information 135 may be different from those registered in the operation schedule information 134 due to an accident or another trouble, or a cancellation (for example, no-showup, etc.).

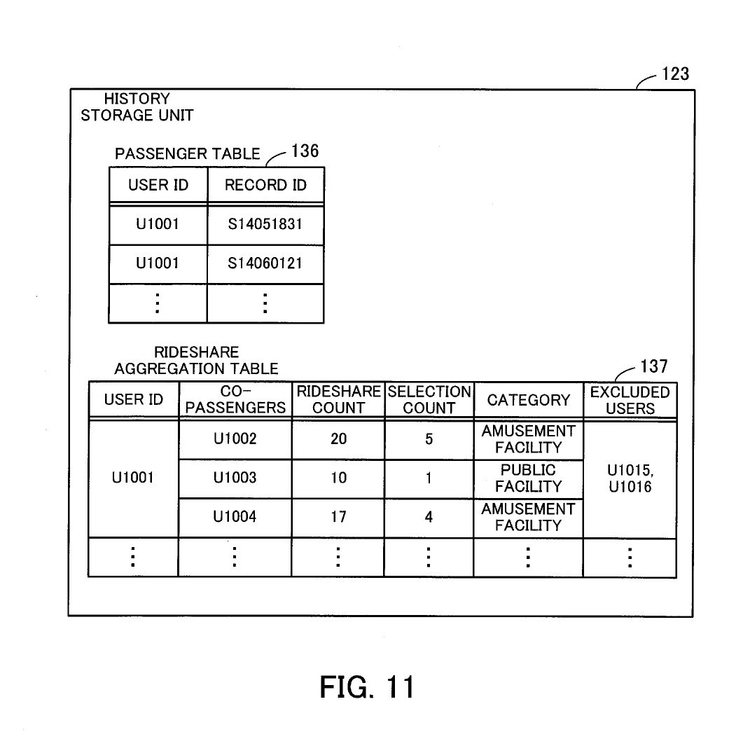

FIG. 11 illustrates an example of a passenger table and a rideshare aggregation table.

The passenger table 136 is stored in the history storage unit 123. The passenger table 136 is updated by the operation record collecting unit 124 when the operation record information 135 is stored in the history storage unit 123. The passenger table 136 includes the following fields: user ID and record ID. The user ID in the passenger table 136 identifies a user who took a vehicle trip. The record ID in the passenger table 136 identifies the operation record information 135 of the vehicle trip. In the passenger table 136, there are many-to-many correspondences between user IDs and record IDs. That is to say, the passenger table 136 indicates which users took which vehicle trips. The user IDs of users who took vehicle trips are extracted from the operation record information 135.

The rideshare aggregation table 137 is stored in the history storage unit 123. The rideshare aggregation table 137 is updated by the user relationship analysis unit 125 analyzing the operation record information 135 and the passenger table 136. This analysis may be carried out by batch processing when information about vehicle trips for a fixed time period is accumulated in the history storage unit 123. The rideshare aggregation table 137 includes the following fields: user ID, co-passengers, rideshare count, selection count, category, and excluded users.

The user ID indicates a user who has used the public transportation system. The co-passengers are other users who got off at the same location in the same vehicle trip as the user identified by the user ID. For example, the user relationship analysis unit 125 searches the passenger table 136 for vehicle trips taken by a user. Then, the user relationship analysis unit 125 specifies the drop-off location of the user from the operation record information 135 about each found vehicle trip, and detects other users who got off the same location. The co-passengers are represented using user IDs registered in the user table 131.

The rideshare count indicates how many times the user indicated by the user ID and a “co-passenger” rode together in the past, i.e., how many times the user and the “co-passenger” got off at the same location in the same vehicle trip. This rideshare count is counted with reference to the operation record information 135 and the passenger table 136 in the way described above. The vehicle trips to be used for counting the rideshare count may be limited to ones that were operated during a predetermined recent period. The selection count indicates how many times the user identified by the user ID selected the “co-passenger” on the screen 53. The selection count is updated by the co-passenger candidate determination unit 127 according to a selection notification. The selection count may be reset at a fixed time interval. In this connection, a selection proportion calculated by dividing the selection count by the number of times the “co-passenger” was displayed on the screen 53 may be registered in place of the selection count.

The category indicates the type of a location where the user identified by the user ID and the “co-passenger” got off a vehicle, and location types are registered in the location table 132. The rideshare count is counted for each category of drop-off locations. For example, assume the case where a user and another user got off together m times at a location where there was an amusement facility nearby, and got off together n times at a location where there was a public facility (for example, library or city hall) nearby. In this case, the rideshare count m for the amusement facility and the rideshare count n for the public facility are counted separately.

The excluded users are other users who do not become co-passenger candidates for the user identified by the user ID. The excluded users are represented using user IDs registered in the user table 131. The user may register such excluded users in the rideshare aggregation table 137 in advance. The reservation management server 100 determines co-passenger candidates, expecting that other users who rode together with a user with a high frequency are friends or acquaintances of the user. In the case where the determination made by the reservation management server 100 is not proper (for example, other users who rode together with a high frequency are not friends or acquaintances), these users may be registered as excluded users, thereby improving the detection accuracy.

In this connection, in order to improve the accuracy of determining co-passenger candidates, the user relationship analysis unit 125 may exclude vehicle trips satisfying predetermined conditions among past vehicle trips and then counts the rideshare count. For example, in commuter hours, many users who are not friends or acquaintances may take the same vehicle trip and get off at a location where there are stations or working places nearby. Therefore, there is an idea that the user relationship analysis unit 125 counts the rideshare count, excepting vehicle trips that were operated during the commuter hours.

The following describes messages communicated between the reservation management server 100 and the user terminals 200, 200a, and 200b. The following describes the case where the user of the user terminal 200 makes a reservation for a seat and gives a rideshare offer to the user of the user terminal 200a.

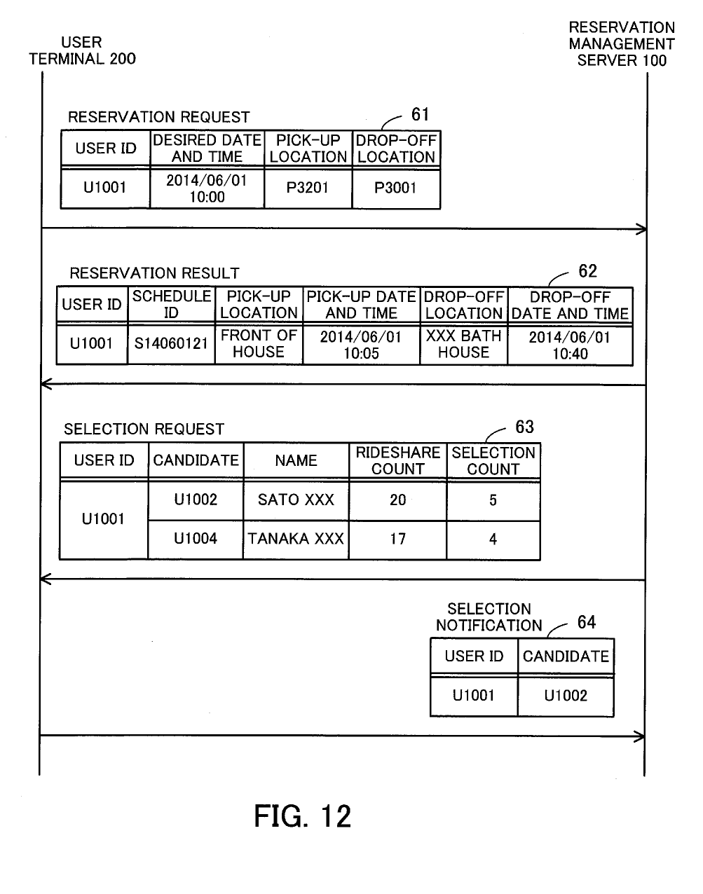

FIG. 12 illustrates an example of messages between a reserving user and the reservation management server.

The user terminal 200 sends a reservation request 61 to the reservation management server 100. The reservation request 61 includes the following data items: user ID, desired date and time, pick-up location, and drop-off location. The user ID indicates the user using the user terminal 200. The desired date and time, pick-up location, and drop-off location are the same as those entered by the user on the screen 51. In this connection, the pick-up and drop-off locations are represented using location IDs registered in the location table 132. Information indicating a correspondence between a location name and a location ID may previously be stored in the user terminal 200 or may be downloaded, as needed, from the reservation management server 100 to the user terminal 200.

The reservation management server 100 sends a reservation result 62 to the user terminal 200 in response to the reservation request 61. The reservation result 62 includes the following data items: user ID, schedule ID, pick-up location, pick-up date and time, drop-off location, and drop-off date and time. The user ID is the same as that included in the reservation request 61. The schedule ID is included in the operation schedule information 134, and identifies the reserved vehicle trip. The pick-up location and the drop-off location are the same as those specified in the reservation request 61. However, for a simple display of the screen 52, the pick-up and drop-off locations are represented using the names of the locations in the reservation result 62. The pick-up date and time indicate the scheduled date and time of arrival of the reserved vehicle trip at the pick-up location. The drop-off date and time indicate the scheduled date and time of arrival of the reserved vehicle trip at the drop-off location.

The reservation management server 100 sends a selection request 63 to the user terminal 200 after the reservation result 62. The selection request 63 includes the following data items: user ID, candidate, name, rideshare count, and selection count. The user ID is the same as that included in the reservation request 61 and the reservation result 62. The candidate is another user (co-passenger candidate) who possibly takes the reserved vehicle trip, and is determined with reference to the rideshare aggregation table 137. The candidate is represented using a user ID. The name is the name of the candidate. The rideshare count indicates how many times the user using the user terminal 200 and the candidate rode together in the past. The selection count indicates how many times the user using the user terminal 200 selected the candidate for giving a rideshare offer, on the screen 53.

The user terminal 200 sends a selection notification 64 to the reservation management server 100 in response to the selection request 63. The selection notification 64 includes the following data items: user ID and candidate. The user ID is the same as that included in the selection request 63. The candidate is another user selected by the user on the screen 53, and is represented using a user ID. The user may not select any co-passenger candidates on the screen 53, or may select a plurality of co-passenger candidates. Therefore, no user ID or one or more user IDs are included as candidates in the selection notification 64.

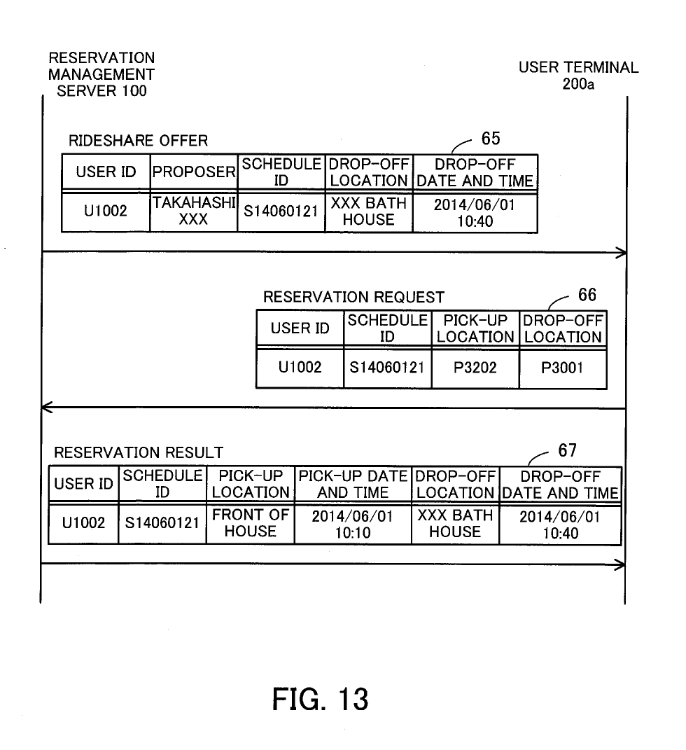

FIG. 13 illustrates an example of messages communicated between the reservation management server and a co-passenger candidate.

When the user (reserving user) of the user terminal 200 selects the user (co-passenger candidate) of the user terminal 200a, the reservation management server 100 sends a rideshare offer 65 to the user terminal 200a. The rideshare offer 65 includes the following data items: user ID, proposer, schedule ID, drop-off location, and drop-off date and time. The user ID indicates a co-passenger candidate. The proposer is a reserving user. For a simple display on the screen 54, the proposer is represented using his/her name. The schedule ID indicates a reserved vehicle trip. The drop-off location is a location where the reserving user is to drop off. For a simple display on the screen 54, the drop-off location is represented using the name of the location. The drop-off date and time is a schedule date and time of arrival at the drop-off location.

The user terminal 200a sends a reservation request 66 to the reservation management server 100 in response to the rideshare offer 65. The reservation request 66 includes the following data items: user ID, schedule ID, pick-up location, and drop-off location. The user ID, pick-up location, and drop-off location are the same as those included in the reservation request 61. The schedule ID indicates the reserved vehicle trip. The reservation request 66 requests that the user of the user terminal 200a takes the same vehicle trip as the user of the user terminal 200. Therefore, although a desired date and time is specified in the reservation request 61, a schedule ID is specified in the reservation request 66. In this connection, the pick-up location specified by the co-passenger candidate may be different from that specified by the reserving user.

The reservation management server 100 sends a reservation result 67 to the user terminal 200a in response to the reservation request 66. The reservation result 67 includes the following data items: user ID, schedule ID, pick-up location, pick-up date and time, drop-off location, and drop-off date and time. These data items are the same as those included in the reservation result 62. The user using the user terminal 200a is not a user who makes a reservation independently, but is a co-passenger offered by a reserving user who made a reservation independently. Therefore, a selection request is not sent after the reservation result 67.

The following describes processes that are performed by the reservation management server 100 and the user terminal 200. The user terminals 200a and 200b may operate in the same way as the user terminal 200 does.

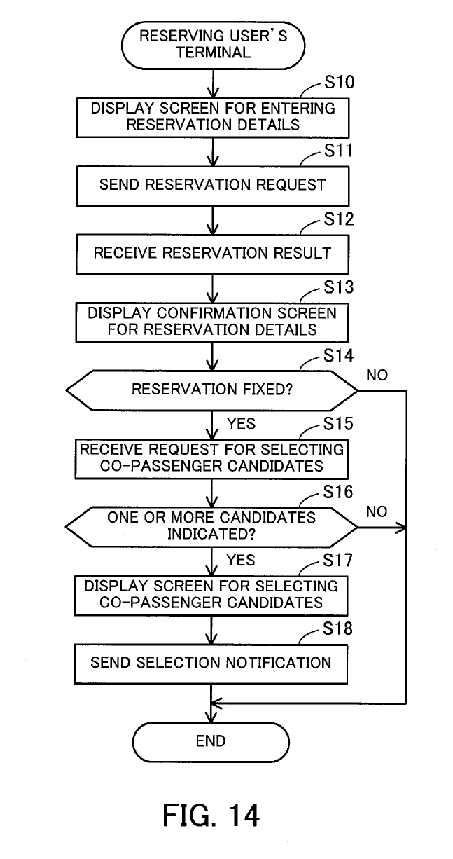

FIG. 14 is a flowchart illustrating an example of a procedure for a process that is performed by a reserving user's terminal.

This example describes the case where the user of the user terminal 200 makes a reservation for a seat.

(S10) The screen control unit 222 displays the screen 51 for entering the details of a reservation, on the display 205. The details of a reservation include information about a desired date and time, a pick-up location, and a drop-off location. The pick-up and drop-off locations may be selected from a plurality of available stop locations. The information indicating the available stop locations is obtained from, for example, the reservation management server 100. When displaying the screen 51, the screen control unit 222 obtains the current position of the user terminal 200 measured by the GPS receiver 208. The screen control unit 222 then compares the current position with the home position indicated by the positional information stored in the user information storage unit 221 to determine whether the user using the user terminal 200 is at home or not. When the user is at home, the initial value of the pick-up location is set to “front of house” of the user.

(S11) The message communication unit 223 sends the reservation request 61 indicating the details of the reservation entered on the screen 51, to the reservation management server 100. The reservation request 61 includes the user ID of the user making the reservation, in addition to the entered desired date and time, pick-up location, and drop-off location. In this connection, before the screen 51 is displayed, a login procedure may be carried out between the user terminal 200 and the reservation management server 100 using the user ID and password.

(S12) The message communication unit 223 receives the reservation result 62 from the reservation management server 100. If the reservation is rejected due to no empty seats available, reservation deadline being passed, or another reason, the reservation result 62 includes information indicating the reservation has been rejected. If the reservation is fixed, on the other hand, the reservation result 62 includes information about a schedule ID, pick-up location, pick-up date and time, drop-off location, and drop-off date and time. The schedule ID identifies a vehicle trip, which is indicated by a combination of a date, a time period, and a vehicle. The pick-up date and time and the drop-off date and time are estimated by the reservation management server 100 on the basis of the current traveling route.

(S13) The screen control unit 222 displays the screen 52 according to the reservation result 62 on the display 205. If the reservation has been rejected due to no empty seats available, reservation deadline being passed, or another reason, the rejection of the reservation is indicated on the screen 52. If the reservation has been fixed, on the other hand, the date and time period of the reserved vehicle trip, the pick-up location, the pick-up time, the drop-off location, and the scheduled drop-off time are displayed on the screen 52.

(S14) The screen control unit 222 determines based on the reservation result 62 whether the reservation has been fixed or not. If the reservation has been fixed, the process proceeds to step S15. If the reservation has been rejected, the process of the reserving user's terminal is completed. At this time, the screen 51 may be displayed on the display 205 again.

(S15) The message communication unit 223 receives the selection request 63 from the reservation management server 100. In this connection, the message communication unit 223 may receive the selection request together with the reservation result 62. The selection request 63 includes a list of co-passenger candidates and information about the rideshare count and selection count of each co-passenger candidate. The list may include two or more co-passenger candidates. In addition, if there are no users satisfying the conditions, the list may include no co-passenger candidate.

(S16) The screen control unit 222 determines whether one or more co-passenger candidates are indicated in the selection request 63 or not. If one or more co-passenger candidates are indicated, the process proceeds to step S17. If no co-passenger candidates are indicated, the process of the reserving user's terminal is completed.

(S17) The screen control unit 222 displays the screen 53 according to the selection request 63 on the display 205. On the screen 53, the name, the rideshare count, and the selection count for each co-passenger candidate are displayed. The user of the user terminal 200 selects co-passenger candidates to give an offer to take the reserved vehicle trip together. The user may select two or more co-passenger candidates. On the other hand, the user may not select any co-passenger candidate. In this connection, the rideshare count and the selection count are displayed on the screen 53 for supporting the user to select co-passenger candidates.

(S18) The message communication unit 223 sends the selection notification 64 to the reservation management server 100. The selection notification 64 includes information indicating co-passenger candidates selected by the user.

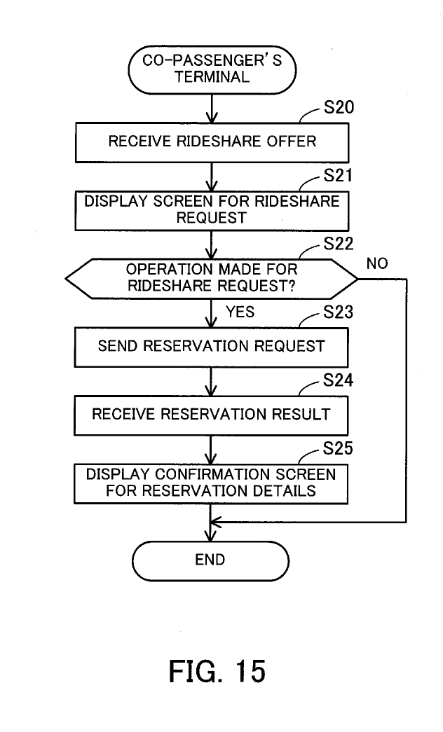

FIG. 15 is a flowchart illustrating a procedure for a process to be performed by a co-passenger's terminal.

This example describes the case where the user of the user terminal 200 is selected as a co-passenger candidate.

(S20) The message communication unit 223 receives the rideshare offer 65 from the reservation management server 100. The rideshare offer 65 includes information about a proposer, a schedule ID, a drop-off location, and drop-off date and time. The proposer is another user who selected the user of the user terminal 200 as a co-passenger candidate. The schedule ID indicates a vehicle trip reserved by the proposer. In this connection, the message communication unit 223 may receive the rideshare offer 65 as an electronic mail. Alternatively, the message communication unit 223 may access the reservation management server 100 to obtain the rideshare offer 65 when receiving electronic mails. Yet alternatively, the message communication unit 223 may periodically access the reservation management server 100 to confirm whether there is any rideshare offer 65 directed to the user terminal 200 or not.

(S21) The screen control unit 222 displays the screen 55 according to the rideshare offer 65 on the display 205. On the screen 55, the name of the proposer, the date and time period of the vehicle trip reserved by the proposer, the drop-off location, and the scheduled drop-off time are displayed. Then, the screen control unit 222 displays the screen 56 on the display 205. When the user of the user terminal 200 wants rideshare, the user of the user terminal 200 enters a pick-up location on the screen 56. The user does not need to enter a desired date and time and a drop-off location because these are the same as the proposer reserved. If the user of the user terminal 200 does not want rideshare, on the other hand, the user of the user terminal 200 makes some operation on the screen 56 so as not to request the reservation.

In this connection, the pick-up location may be selected from a plurality of available stop locations. Information indicating the available stop locations is obtained from, for example, the reservation management server 100. When displaying the screen 56, the screen control unit 222 obtains the current position of the user terminal 200 measured by the GPS receiver 208. The screen control unit 222 then compares the current position with the home position indicated by the positional information stored in the user information storage unit 221 to determine whether the user using the user terminal 200 is at home or not. When the user is at home, the initial value of the pick-up location is set to “front of house” of the user.

(S22) The screen control unit 222 determines whether the user of the user terminal 200 made some operations on the screen 56 to request the rideshare or not. If such operations were made, the process proceeds to step S23. If such operation were not made, the process of the co-passenger's terminal is completed.

(S23) The message communication unit 223 sends the reservation request 66 to the reservation management server 100. The reservation request 66 includes information about the user ID of the user using the user terminal 200, the schedule ID, and the entered pick-up and drop-off locations. The schedule ID and drop-off location indicated in the rideshare offer 65 may be used in the reservation request 66.

(S24) The message communication unit 223 receives the reservation result 67 from the reservation management server 100. If the reservation has been rejected due to no empty seats available, reservation deadline being passed, or another reason, the reservation result 67 includes information indicating the rejection of the reservation. If the reservation has been fixed, on the other hand, the reservation result 67 includes information about the schedule ID, the pick-up location, pick-up date and time, the drop-off location, and drop-off date and time. The pick-up date and time and the drop-off date and time are estimated by the reservation management server 100 on the basis of the current traveling route.

(S25) The screen control unit 222 displays the screen 56 according to the reservation result 67 on the display 205. If the reservation has been rejected due to no empty seats available, reservation deadline being passed, or another reason, the rejection of the reservation is indicated on the screen 56. If the reservation has been fixed, on the other hand, the date and time period of the reserved vehicle trip, the pick-up location, the pick-up time, the drop-off location, and the scheduled drop-off time are displayed on the screen 56.

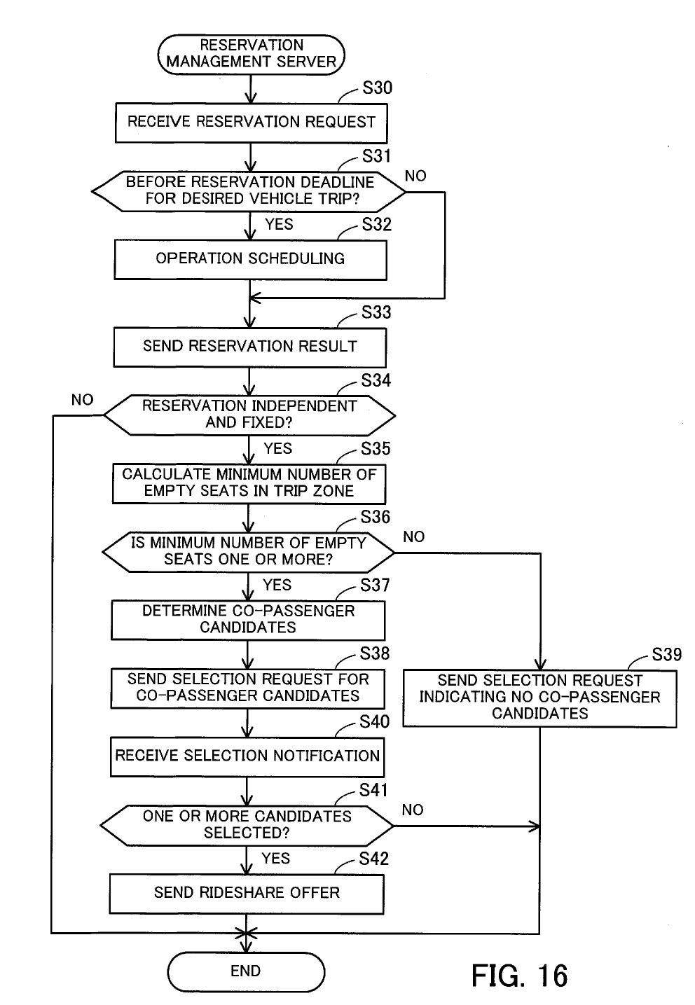

FIG. 16 is a flowchart illustrating a procedure for a process performed by a reservation management server.

(S30) The message communication unit 129 receives the reservation request 61 or the reservation request 66.

(S31) The operation schedule update unit 126 confirms the departure time of the vehicle trip satisfying the desired date and time specified by the reservation request 61 or the vehicle trip specified by the reservation request 66. The departure time is specified with reference to, for example, the operation schedule information 134. Then, the operation schedule update unit 126 determines whether the current date and time is before the reservation deadline for the vehicle trip or not (for example, a predetermined time period or more, such as 30 minutes or more, ahead of the departure time). If the current time is before the reservation deadline, the process proceeds to step S32. If the reservation deadline has passed, the rejection of the reservation is determined, and then the process proceeds to step S33.

(S32) The operation schedule update unit 126 computes the operation schedule according to the reservation request 61 or the reservation request 66. At this time, the operation schedule update unit 126 calculates the minimum number of empty seats in the specified trip zone on the basis of the number of seats registered in the vehicle table 133 and the passenger entering and existing state registered in the operation schedule information 134. If the minimum number of empty seats is zero, the reservation is rejected due to no empty seats available. If the minimum number of empty seats is one or more, the operation schedule update unit 126 computes the traveling route that passes though the pick-up and drop-off locations specified by the reservation request 61 or the reservation request 66, with the node insertion algorithm or another algorithm, and updates the operation schedule information 134.

(S33) The message communication unit 129 sends the reservation result 62 corresponding to the reservation request 61 or the reservation result 67 corresponding to the reservation request 66. If the reservation has been rejected due to no empty seats, reservation deadline being passed, or another reason, the reservation result 62 or the reservation result 67 includes information indicating the rejection of the reservation.

(S34) The operation schedule update unit 126 determines whether or not the reservation has been fixed at step S32 and the fixed reservation is an independent reservation. The independent reservation is not a reservation requested in response to a rideshare offer given from another user, but a reservation fixed in response to the reservation request 61. If these conditions are satisfied, the process proceeds to step S35. If these conditions are not satisfied, then the reservation process is completed.

(S35) The operation schedule update unit 126 calculates the latest minimum number of empty seats in the trip zone specified by the reservation request 61, on the basis of the number of seats registered in the vehicle table 133 and the passenger entering and existing state registered in the operation schedule information 134 updated at step S32.

(S36) The operation schedule update unit 126 determines whether or not the minimum number of empty seats calculated at step S35 is one or more. If the minimum number of empty seats is one or more, that is, if there is any empty seat other than the currently reserved seat, the process proceeds to step S37. If the minimum number of empty seats is zero, that is, if there are no more empty seats other than the currently reserved seat, the process proceeds to step S39.

(S37) The co-passenger candidate determination unit 127 determines co-passenger candidates for the user (reserving user) having sent the reservation request, with reference to the rideshare aggregation table 137. This process is to estimate friends and acquaintances of the reserving user, on the basis of the trip history of each user.

For example, as a first determination method, the co-passenger candidate determination unit 127 extracts another user whose rideshare count of rideshare with the reserving user is equal to or greater than a threshold, from the rideshare aggregation table 137, and determines the extracted other user as a co-passenger candidate. As a second determination method, the co-passenger candidate determination unit 127 extracts another user who rode together with the reserving user more frequently than accidentally, through an analytical process from the rideshare aggregation table 137, and determines the extracted other user as a co-passenger candidate. At this time, the co-passenger candidate determination unit 127 confirms excluded users registered in association with the reserving user in the rideshare aggregation table 137 so as not to include the excluded users as the co-passenger candidates.

In the above second determination method, for example, the co-passenger candidate determination unit 127 assumes that the number of times two users ride together accidentally is based on the following Poisson distribution: p(k)=λ^{k}×e^{-λ}/k!. In this Poisson distribution, the symbol k denotes the number of rideshares indicating how many times two users rode together. The symbol p denotes a probability of occurrence of the number of rideshares. The symbol A denotes an average number of rideshares among all combinations of users. The symbol e denotes Napier's constant, and the symbol ! denotes factorial. The co-passenger candidate determination unit 127 calculates λ and k with reference to the rideshare aggregation table 137, and assuming that another user whose p is lower than or equal to a threshold (for example, 0.01 or lower) rode together with the reserving user intentionally, not accidentally, determines the other user as a co-passenger candidate.

In this connection, the rideshare count to be used in determining co-passenger candidates may be calculated, irrespective of the categories of drop-off locations. In this case, the co-passenger candidate determination unit 127 calculates a sum of the rideshare counts registered for the respective categories in the rideshare aggregation table 137. On the other hand, the rideshare count to be used in determining co-passenger candidates may be calculated with taking the categories of the drop-off locations into account. In this case, the co-passenger candidate determination unit 127 specifies the category of the drop-off location currently specified by the reserving user, with reference to the location table 132, and uses the rideshare count corresponding to the category. This makes it possible to distinguish friends to go to an amusement facility together and friends to go to a shopping center together, and to thereby determine friends who possibly take the currently reserved vehicle trip together, as co-passenger candidates.

In addition, the co-passenger candidate determination unit 127 narrows down the co-passenger candidates according to the minimum number of empty seats calculated at step S35. For example, the co-passenger candidate determination unit 127 reduces the number of co-passenger candidates down to the minimum number of empty seats or a value obtained by adding a predetermined value to the minimum number of empty seats. The reason why co-passenger candidates more than the minimum number of empty seats are extracted is because the reserving user may not always select all the co-passenger candidates and because all the selected co-passenger candidates may not want rideshare. To narrow down the co-passenger candidates, the co-passenger candidate determination unit 127 may preferentially determine, as co-passenger candidates, users whose rideshare counts are high with reference to the rideshare aggregation table 137. Alternatively, the co-passenger candidate determination unit 127 may preferentially determine, as co-passenger candidates, users whose selection counts are high with reference to the rideshare aggregation table 137.

(S38) The message communication unit 129 sends the selection request 63 listing the co-passenger candidates determined at step S37 to the reserving user. Then, the process proceeds to step S40.

(S39) The message communication unit 129 sends the selection request 63 indicating no co-passenger candidates to the reserving user. Then, this reservation process is completed.

(S40) The message communication unit 129 receives the selection notification 64 corresponding to the selection request 63. The selection notification 64 includes information about co-passenger candidates selected by the reserving user. There may be no co-passenger candidate selected or there may be one or more passenger candidates selected.

(S41) The rideshare offering unit 128 determines on the basis of the selection notification 64 received at step S40 whether one or more co-passenger candidates have been selected or not. If one or more co-passenger candidates have been selected, the process proceeds to step S42. If no co-passenger candidate has been selected, this reservation process is completed.

(S42) The message communication unit 129 sends the rideshare offer 65 to the co-passenger candidates selected by the reserving user. The rideshare offer 65 may be sent via an electronic mail or with another communication method which performs transmission to the user terminals used by the co-passenger candidates without waiting for access from the user terminal. Alternatively, the rideshare offer 65 may be sent in response to access from the user terminals used by the co-passenger candidates. In this connection, at this stage, the rideshare offering unit 128 narrows down the co-passenger candidates for the rideshare offer 65 according to the minimum number of empty seats calculated at step S35.

In the above description, reservation requests from users, rideshare offers to other users, and reservation requests from the other users are made by sending messages over the network 30. Alternatively, some or all of these requests and offers may be made verbally on the phone.

For example, the following workflow which involves an operator may be considered. The operator receives a reservation from a user on the phone, and enters the details of the reservation in the reservation management server 100. Then, the reservation management server 100 determines co-passenger candidates, and displays information about the co-passenger candidates on the display 111. The operator makes telephone calls to the co-passenger candidates on the basis of the information about the displayed co-passenger candidates to offer them the same vehicle trip. When a co-passenger candidate accepts the offer, the operator enters the details of the reservation for the co-passenger candidate in the reservation management server 100.

According to the information processing system of the second embodiment, when a user makes a reservation for a vehicle trip in the demand responsive transport system, other users (co-passenger candidates) who frequently went along with the reserving user are determined based on the trip history of each of a plurality of users. Then, the use of the same vehicle trip is offered to the determined other users.

As described above, the use of a vehicle trip is offered focusing on the human relationship between users, which makes it possible to lower the psychological barrier of a user who received the offer and to increase the possibility that the user takes the same vehicle trip as a reserving user. In addition, even if a plurality of other users who rode together with the reserving user do not know each other, the plurality of other users may get to know each other via the reserving user. In addition, when a user in a group of friends makes a reservation for a vehicle trip, the other users in the group are automatically notified of this reservation. Therefore, the users in the group do not need to adjust the schedule of which vehicle trip to take, which simplifies the reservation procedure.

As a result, the number of passengers or the vehicle occupancy is improved. For example, there is a possibility that a rideshare offer stimulates the potential demand of another user, and thus an aggregate demand for the demand responsive transport system may be increased. In addition, the rideshare offer increases the possibility that a user and another user take the same vehicle trip while reducing the possibility that these users make reservations for different vehicle trips, which leads to facilitating the efficient operation of the demand responsive transport system while decreasing the number of vehicle trips.

It is noted that, as described earlier, the information processing of the first embodiment is implemented by causing a computer to execute an intended program. The information processing of the second embodiment is implemented by causing the reservation management server 100 and the user terminals 200, 200a, and 200b to execute an intended program.

The program may be recorded on a computer-readable recording medium (for example, recording medium 113). As such recording media, for example, magnetic disks, optical discs, magneto-optical disks, semiconductor memories, or others may be used. The magnetic disks include FDs and HDDs. The optical discs include CDs, CD-Rs (Recordable), CD-RWs (Rewritable), DVDs, DVD-Rs, and DVD-RWs. The program may be recorded on portable recording media, which may then be distributed. In this case, the program may be copied from a portable-recording medium to a HDD or another recording medium (for example, HDD 103), and then may be executed.

According to one aspect, it is possible to encourage a plurality of users to take the same vehicle trip.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A reservation management method comprising:
obtaining, by a processor, reservation information including reserved trip information and reserving user information, the reserved trip information indicating a first vehicle trip that has not departed and is reserved by a user of a plurality of users, the reserving user information indicating the user;
determining, by the processor, with reference to history information associating information about users who took individual ones of a plurality of second vehicle trips that were operated with different departure dates and times in a past among the plurality of users with trip information indicating the individual second vehicle trips, one or more other users each associated with same trip information as the user from the plurality of users; and
outputting, by the processor, other user information indicating some or all of the determined one or more other users in association with the reservation information.

2. The reservation management method according to claim 1, wherein the outputting other user information includes sending the reservation information to addresses corresponding to the some or all of the determined one or more other users over a network.

3. The reservation management method according to claim 1, wherein:
the history information associates drop-off location information indicating, among a plurality of locations, a drop-off location of each of the users who took the individual second vehicle trips with the information about the each user; and
the determined one or more other users are other users each associated with a combination of the same trip information and same drop-off location information as the user in the history information.

4. The reservation management method according to claim 3, wherein the determined one or more other users are other users each satisfying conditions that the each other user is associated with combinations of the same trip information and the same drop-off location information as the user and a number of the combinations is greater than or equal to a threshold.

5. The reservation management method according to claim 3, wherein:
the reservation information includes scheduled drop-off location information indicating a scheduled drop-off location of the user; and
the determining one or more other users includes
determining, with reference to location information indicating categories of individual ones of the plurality of locations, a category of the scheduled drop-off location indicated by the scheduled drop-off location information, and
determining the one or more other users each satisfying conditions that, among drop-off locations indicated by the same drop-off location information, a number of drop-off locations whose categories are same as the category of the scheduled drop-off location is greater than or equal to a threshold in the history information.

6. A non-transitory computer-readable storage medium storing therein a computer program that causes a computer to execute a process including:
obtaining reservation information including reserved trip information and reserving user information, the reserved trip information indicating a first vehicle trip that has not departed and is reserved by a user of a plurality of users, the reserving user information indicating the user;
determining, with reference to history information associating information about users who took individual ones of a plurality of second vehicle trips that were operated with different departure dates and times in a past among the plurality of users with trip information indicating the individual second vehicle trips, one or more other users each associated with same trip information as the user from the plurality of users; and
outputting other user information indicating some or all of the determined one or more other users in association with the reservation information.

7. A reservation management apparatus comprising:
a memory configured to store history information associating information about users who took individual ones of a plurality of vehicle trips that were operated with different departure dates and times in a past among a plurality of users with trip information indicating the individual vehicle trips; and
a processor configured to execute a process including:
obtaining reservation information including reserved trip information and reserving user information, the reserved trip information indicating another vehicle trip that has not departed and is reserved by a user of the plurality of users, the reserving user information indicating the user,
determining, with reference to the history information, one or more other users associated with same trip information as the user from the plurality of users, and
outputting other user information indicating some or all of the determined one or more users in association with the reservation information.
